(19) United States
(12) Patent Application Publication
(10) Pub. No.: US 2007/0094056 A1
(43) Pub. Date: Apr. 26, 2007

(54) System, method, and computer program product for reducing the burden on an inventory system by retrieving, translating, and displaying attributes information corresponding to travel itineraries listed in the inventory system

(75) Inventors: Alice Kang, New York, NY (US); Joshua Hartmann, Brooklyn, NY (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Travelocity.com LP.

(21) Appl. No.: 11/258,483

(22) Filed: Oct. 25, 2005

(51) Int. Cl. G06Q 10/00

(52) U.S. Cl. 705/5

(57) ABSTRACT

The present invention generates a concise listing of low-priced travel itinerary options including attributes information that discloses amenities or incentives that may be offered with the listed itinerary options. The invention generates the listing in response to a user input after retrieving itinerary options from an inventory system. The invention also retrieves data corresponding to the retrieved itinerary options and translates the data into attributes information that may be displayed to a user along with the listing of itinerary options. The user is thus informed of attributes corresponding to selected itinerary options prior to purchasing one of the itinerary options.

### BACKGROUND OF THE INVENTION

1. Field of the Invention

The present invention relates to the field of mechanized inventory systems, such as airline reservations systems or other product and/or service reservation or inventory systems, which are used to determine availability and pricing for products and/or services. More particularly, the embodiments of the present invention are adapted to determine and display attributes information related to available products and/or services in an interactive format such that a user may be made aware of attributes corresponding to travel itineraries or other products retrieved from an inventory system.

2. Description of Related Art

Many of today's products and services are catalogued in computerized reservation or inventory systems. These systems may include simple or complex methodologies for maintaining inventory and providing product and/or service availability information. Either via direct access or remote access across a network, consumers can run queries and view availability information for selected products and/or services, as well as purchase or reserve such items. One example of such systems is a computerized reservation system (CRS). A CRS provides a communications network for travel agents and other consumers to access travel related information such as airline seat availability, hotel reservations, car rentals, event availability, leisure activities, etc. CRS systems have been in existence for a long period of time. Some of the current CRS systems are known or referred to under the following trade names and services marks: SABRE, AMADEUS, WORLDSPAN, SYSTEM ONE, APOLLO, GEMINI, GALILEO, and AXESS.

Consumer interaction with these systems has evolved in recent years. Initially, these systems were difficult to use and did not always provide the best solution to a consumer's query. For example, in the early stages, a consumer interested in booking airline tickets would input a desired flight itinerary with desired travel dates and times and possible selected class of travel. The CRS system would check availability for the dates and return with a fare price meeting the specific input dates and times requested. Although there were some algorithms in place to aid the consumer in finding the lowest-priced fare, these algorithms were typically geared more toward providing quick results with less computing time and resources than in finding the lowest priced fare. For example, some early product availability and booking algorithms used a method that would heuristically select a subset of itineraries from a larger pool of itineraries, price this subset, and select the lowest-priced fare from the subset for display to the consumer. While these early systems provided timely results and reduced processing load on the CRS, they did not always provide the best solution to the consumer.

In light of this, the assignees of the present invention, developed an algorithm, (sometimes referred to as extended implicit enumeration algorithm), that could be used to efficiently determine the lowest fare for a particular flight itinerary. The algorithm used a k-shortest path schema that identified the lowest available fare that met a consumer's request and displayed this fare to the consumer. This algorithm is described more fully in U.S. patent application Ser. No. 09/421,895, filed on Oct. 21, 1999, entitled Method and Apparatus for Searching for a Low Fare for Travel Between Two Locations, and published as a PCT application under Publication No. WO 01/29693; the contents of which are incorporated herein.

The extended implicit enumeration algorithm was a major step forward in efficiently determining the lowest fare price for a given itinerary; it does have a few slight drawbacks. Specifically, the algorithm was designed to provide a small number of low priced answers with minimal consideration of diversity. The consumer inputs a request, and the algorithm returns only the lowest fare meeting the request. Unfortunately, such a process may not provide the best solution to a consumer or may miss an opportunity to market different fares to a customer that may maximize profits for the supplier, while also meeting the consumer's goals. Thus the assignee of the present invention developed a system, method, and computer program product to provide a plurality of low fare prices and different flight itinerary options for a given departure and return date combination, thereby allowing a user to view these different options and make a determination as to which fare and flight itinerary meets their goals as described more fully in U.S. Provisional Patent Application Ser. No. 60/573,546, filed on May 21, 2004, entitled Systems, Methods, and Computer Program Products for Searching and Displaying Low Cost Product Availability Information for a Given Departure-Return Date Combination or Range of Departure-Return Date Combinations; the contents of which are also incorporated herein.

While conventional searching systems for products may provide a user with a multitude of different options in the form of a results listing, the options displayed by such systems are sorted by and include information corresponding to the user input. For example, the results of a search for low-cost airfares may, in conventional systems, include line-by-line listings of flight options that correspond to lowest-cost product options without providing supplemental attributes or offers information that may be pertinent to the user's purchasing decision but may not be reflected in the original user query (which is often limited only to price and itinerary). In addition, while conventional search systems may retrieve data corresponding to one or more aspects of a product option, such systems do not translate such retrieved data into attributes information that may be used by a consumer to make an informed product choice from the listing of product options returned by a conventional search system.

For example, in choosing an airline itinerary, a user may be interested in a particular in-flight amenity that may be offered only by a certain airline or aircraft type, such as in-flight Electrical power, entertainment, and/or communications systems. In addition, while some conventional search tools provide for the graphical display of price and/or departure options for products (such as low-fare airline tickets) in a more concise format (such as a multi-axis display), such tools do not translate data associated with particular flight itineraries (such as the aircraft type or airline) into attributes information (such as the availability of in-flight entertainment, extra legroom, etc. that may only be available on selected aircraft or air carriers). Thus, these conventional search tools lack the capability of providing the user with graphical indications of attributes information related to the various itineraries offered in order to make the user aware of select itineraries that may have desirable supplemental benefits or attributes (such as the above-mentioned comfort attributes or limited-time incentives (such as rebates or double frequent-flier miles promotions)). In addition, conventional search tools providing graphical displays of the options returned by a search also do not allow for the presentation of attributes information in interactive displays embedded in the product listing such that the user may select the interactive display corresponding to the displayed attributes information (displayed, for example on a line listing with a particular product option) and, in response, be presented with an embedded graphical display capable of displaying one or more items of additional attributes information related to the product option.

These limitations in the current system may create a burden on inventory systems. Specifically, since conventional search systems are not capable of translating data related to selected product options (such as flight itineraries) into attributes information, such search systems are incapable of providing the user with attributes information prior to the selection of a particular product option. Thus, the user may be required to run multiple searches or engage a purchasing routine in an attempt to locate product options having a desired amenity. For example, a tall user may seek an amenity such as increased legroom and/or headroom that may be available only on selected aircraft types. In addition, users carrying laptop computers may be interested in purchasing only travel itineraries that offer Electrical power outlets for at least the long-distance leg of a particular itinerary. Conventional search systems lack the capability of translating commonly-retrieved product option data (such as aircraft type or airline) into usable supplemental attributes information (such as Electrical power availability or extra legroom) that may be presented to a user prior to the selection of a product option. Thus, some users will be required to select and de-select various product options in order to more fully ascertain the attributes (such as amenities) offered in conjunction with a particular product option. Further, some attributes (that may be ascertained by translating data often retrieved from a product database with product option information) may not be ascertainable at all by a user until the user actually commences their journey on the selected itinerary. Each time a product option is selected and/or rejected in a user search for such attributes, it places added burden on the inventory system to process the request. In some instances, added systems are required to meet the demand.

Therefore, there exists a need for an improved system to solve the technical problems outlined above that are associated with conventional search systems. More particularly, there exists a need for a system capable of translating data that may be retrieved from a product database along with product option information (such as the aircraft type or airline serving a particular flight itinerary) into attributes information that is accessible by a system user prior to the purchase of a selected product option. There also exists a need for a system capable of providing different product options to a user (in response to a query) along with translated attributes information that may correspond to the multitude of options that may be returned by a search algorithm. In addition, there exists a need for a system that provides a user with a display of such translated attributes information along with each corresponding product option (such as a particular travel itinerary) in a concise graphical format such that the user may review translated attributes information prior to selecting a product option from a listing of product options returned by the system.

### BRIEF SUMMARY OF THE INVENTION

The needs outlined above are met by the present invention which, in various embodiments, also provides a system that overcomes many of the technical problems discussed above, as well other technical problems, with regard to the retrieval, translation, and concise display of supplemental attributes information (such as a listing of amenities or incentives) by conventional low-cost product search systems. Specifically, in one embodiment, the system of the present invention retrieves and displays supplemental information corresponding to one or more travel products selected from a database based on a search request in a manner that reduces the burden on inventory systems. In one embodiment, the system comprises an inventory system comprising travel products wherein for at least some of the travel products said inventory system further comprises data representing at least one of attributes and offers associated with the travel products, and a host computing element in communication with said inventory system for running queries on said inventory system based on a user request. The host computing element may, in some embodiments, retrieve travel products from the inventory system based on the user request and display retrieved travel products meeting the user request to the user wherein, for those retrieved travel products having associated data representing the attributes and/or offers, the host computing element further displays the data representing the attributes and/or offers with the retrieved travel products. In some embodiments, the host computing element may display the retrieved travel products to the user in a graphical display comprising at least one interactive graphical image such that as the host computing element receives a user input comprising a selection of the interactive graphical image, the host computing element may further provide a second graphical image comprising additional attributes and/or offer information corresponding to the retrieved travel products.

Furthermore, in some system embodiments, the host computing element further translates the data associated with the retrieved travel products into attributes and/or offer information corresponding to the retrieved travel products. The host computing element, may also interrogate a translational database comprising data and corresponding attributes and/or offers information, so as to translate the data associated with the retrieved travel products into attributes and/or offer information corresponding to the retrieved travel products. The host computing element may also be capable of determining whether attributes and/or offers information stored in said translational database correspond to the retrieved travel products.

The travel products stored in the inventory system may comprise, for example, airline flights on a selected aircraft type, airline flights on a selected airline, hotel rooms, automobile rentals, and/or events. Furthermore, in some system embodiments comprising a translational database, the translational database may comprise data indicating attributes and/or offers offered with the selected travel product type, such that the host computing element may translate the data into the attributes and/or offer information and thereafter display the attributes associated with the selected travel product type.

Further, the present invention also provides methods and/or computer program products for retrieving and displaying supplemental information corresponding to one or more travel products selected from a database based on a search request in a manner that reduces the burden on an inventory system. As described above, the inventory system may comprise travel products, wherein for at least some of the travel products, the inventory system further comprises data representing at least one of attributes and offers associated with the travel products. In some embodiments, the method comprises: retrieving travel products from an inventory system based on a user request; displaying retrieved travel products meeting the user request to the user; and displaying data representing the attributes and/or offers for those retrieved travel products having associated data representing the attributes and/or offers with the retrieved travel products. The displaying step may further comprise displaying the retrieved travel products to the user in a graphical display comprising at least one interactive graphical image. Furthermore, the method may also comprise receiving a user input, comprising a selection of the interactive graphical image, such that the displaying step may further comprise displaying a second graphical image comprising additional attributes and/or offer information corresponding to the retrieved travel products.

Some method and/or computer program product embodiments further comprise steps for translating the data associated with the retrieved travel products into attributes and/or offers information corresponding to the retrieved travel products. Other method embodiments further comprise interrogating a translational database comprising data and corresponding attributes and/or offers information so as to accomplish the translating step described above. Furthermore, the translating step may further comprise determining whether attributes and/or offers information stored in the translational database correspond to the retrieved travel products.

The method and/or computer program products of the present invention may also comprise retrieving various types of travel products and associated attributes and/or offer data from an inventory system including, but not limited to: airline flights on a selected aircraft type, airline flights on a selected airline, hotel rooms, automobile rentals, events, and/or other travel products. Thus, the translating steps may further comprise translating the data into the attributes and/or offer information corresponding to the selected travel product type. Furthermore, the displaying steps described above may further comprise displaying the attributes and/or offers associated with the selected travel product type to a user in response to one or more user inputs.

Thus the systems, methods, and computer program products for retrieving travel products and displaying attributes and/or offer information corresponding to the travel products, as described in the embodiments of the present invention, provide many advantages that may include, but are not limited to: translating data corresponding to travel products retrieved from a database into usable and easily comprehensible attributes and/or offers information; providing an interactive graphical representation of the translated attributes information corresponding to select itineraries retrieved from the database by a search algorithm; providing the interactive graphical representation in a manner that allows a user to be aware of amenities and/or incentives corresponding to a particular travel product option (such as a low-cost travel itinerary); allowing the user to view details of the attributes information directly from an interactive graphical image; and allowing the user to select a product option having a corresponding attribute or offer that is desirable to the user without the need for repetitive searches for product options having the desirable attribute and/or offer associated therewith.

These advantages and others that will be evident to those skilled in the art are provided in the system, method, and computer program product of the present invention. Importantly, all of these advantages allow the system to display results to a user that include attributes information that may be pertinent to the user's preferences. Since the attributes information is made more readily evident to the user along with a selection of corresponding low-cost product options, the user is less likely to run multiple queries for product options having desired attributes (such as amenities) that can overburden the inventory system.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIGS. 1A and 1B illustrate a typical network environment in which the systems, methods, and computer program products may be implemented according to one embodiment of the present invention.

FIG. 2 is an illustration of the operation flow of the systems, methods, and computer program products in response to a user query including retrieval, translation, and display steps, according to one embodiment of the present invention.

FIG. 3 is an illustration of the operation flow of the systems, methods, and computer program products in response to a user query wherein the translation step further includes accessing a translational database for translating retrieved data into attributes information, according to one embodiment of the present invention.

FIG. 4 is a graphical depiction of an itinerary listing generated according to one embodiment of the systems, methods, and computer program products of the present invention illustrating a listing of low-cost travel itineraries and corresponding attributes shown as graphical images corresponding to selected itineraries.

FIG. 5 is a graphical depiction of an itinerary listing generated according to one embodiment of the systems, methods, and computer program products of the present invention illustrating a listing of low-cost travel itineraries and corresponding attributes information depicted in an interactive graphical image corresponding to selected itineraries that may be accessed to generate a detailed second graphical image containing supplemental attributes information.

FIG. 6 is a graphical depiction of a grid or matrix generated according to one embodiment of the systems, methods, and computer program products of the present invention illustrating various low cost itinerary fares and corresponding attribute information for a given departure and return itinerary.

FIG. 7 is a graphical depiction of a grid or matrix generated according to one embodiment of the systems, methods, and computer program products of the present invention illustrating various low-cost itinerary fares and corresponding attribute information for a given range of departure and return dates.

FIG. 8 is an illustration of the operation flow of the systems, methods, and computer program products in response to a user query wherein the providing step further includes providing an interactive graphical image and wherein the method further comprises receiving a selection of the interactive graphical image and, in response, providing a second graphical image containing additional attributes information, according to one embodiment of the present invention.

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

The various aspects of the present invention mentioned above, as well as many other aspects of the invention are described in greater detail below. The systems, methods, and computer program products of the present invention are described in an airline ticket reservation environment. It must be understood that this is only one example of the use of the present invention. Specifically, the systems, methods, and computer program products of the present invention can be adapted to any number of products and services and are not limited to the airline industry. For example, the present invention may be used with rail and bus itineraries, hotels, cruises, restaurants, car rentals, events including sports and leisure activities, etc.

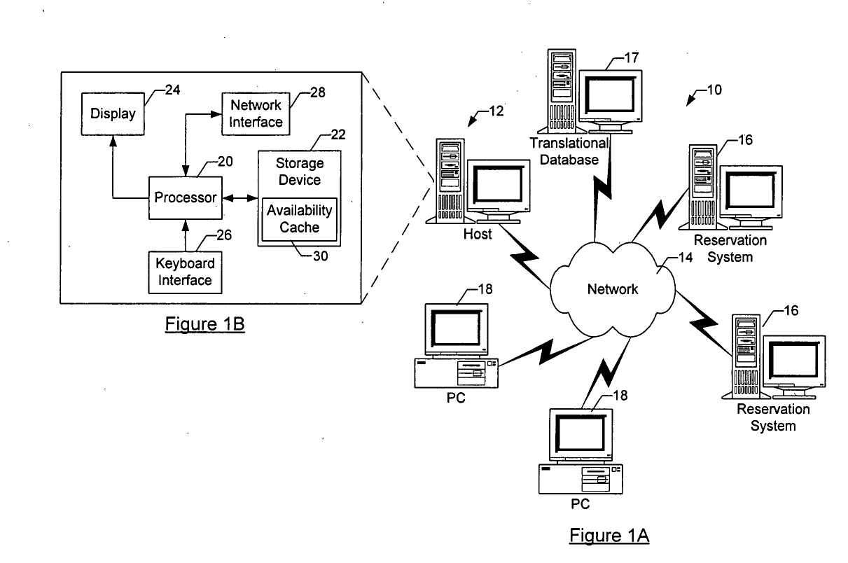

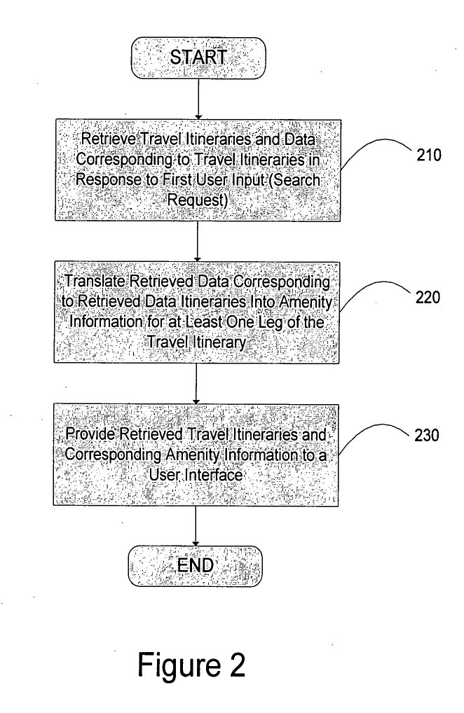

FIGS. 1A and 1B illustrate an example of a typical conventional network environment 10 in which the systems, methods, and computer program products of the present invention may be employed. The network includes a host computer 12 that operates a web site or other similar customer interface. The host computer is typically connected to a network 14, such as a LAN, WAN, Intranet, or Internet, for example. Also connected to the network are various reservation systems 16 containing itineraries, fare information, and availability information for various products sources, such as hoteliers, airlines, car rental companies, etc. Further, users are also connected to the network via personal computers 18 or other types of computing systems. In addition, one or more translational databases 17 may also be connected to the network 14 such that the host computer 12 may be capable of interrogating the translational database 17 so as to be capable of translating data corresponding to itineraries retrieved from the reservation systems 16, into attributes information corresponding to at least one leg of the retrieved itineraries (as described in further detail below with respect to FIG. 2).

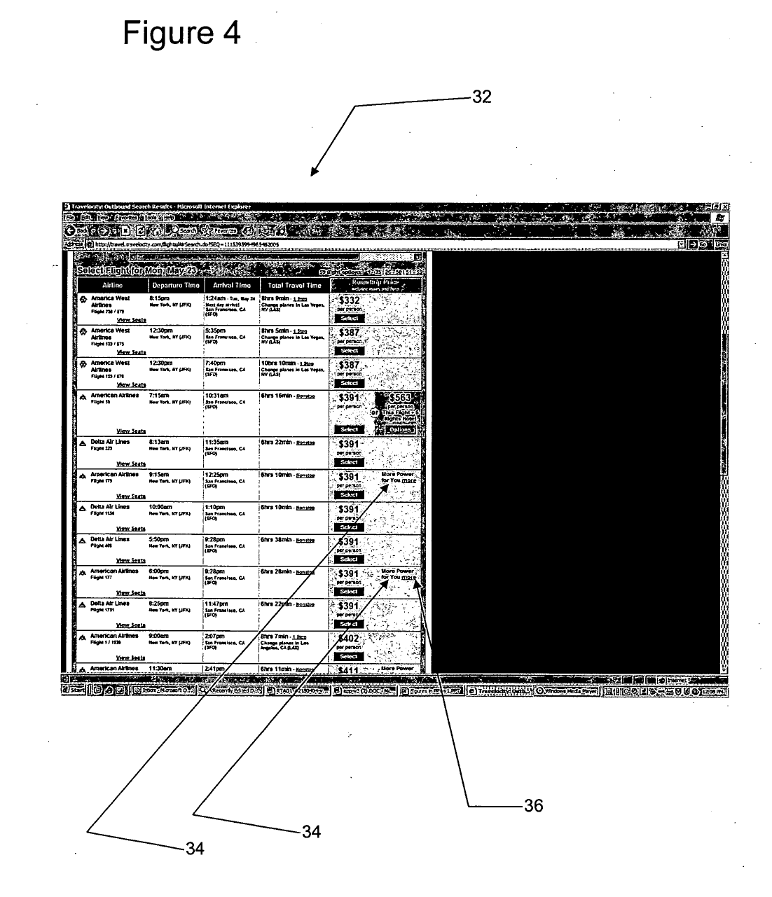

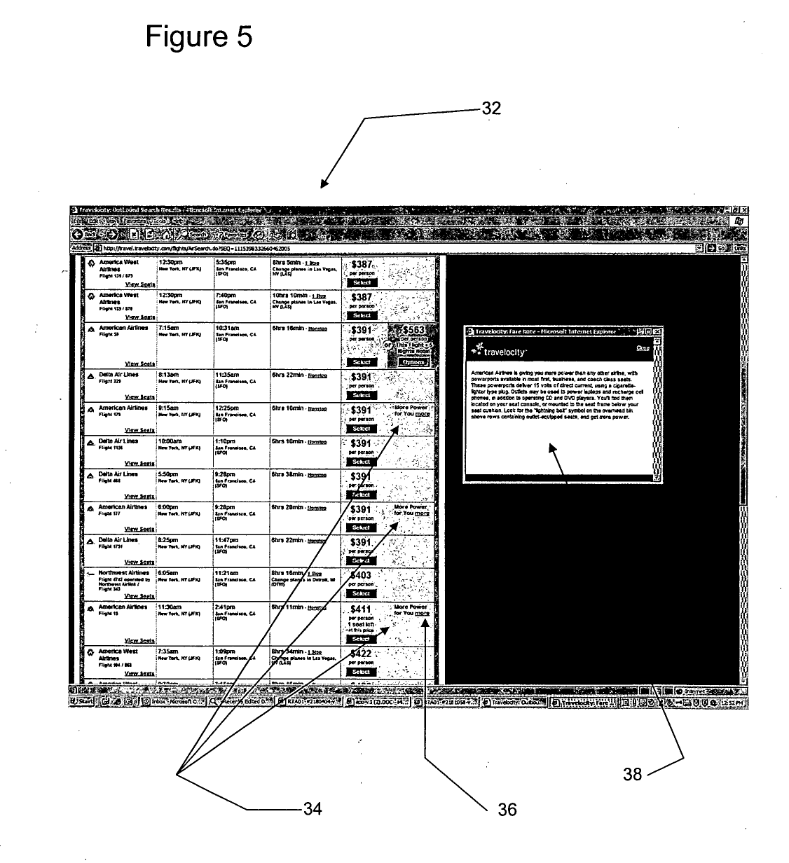

In operation, the system of the present invention, via the host computer 12, provides a web page or other similar electronic form to the user. Using the web page, the user inputs a travel related query. Based on this query, the host computer, in turn, polls the reservation systems 16 of the product providers to retrieve availability information for travel itineraries meeting the requirements of the user query. The host computer 12 also retrieves supplementary data corresponding to the travel itineraries retrieved from the reservation systems 16. Such supplementary data may include, but is not limited to: the aircraft type used in at least one leg of the itinerary, the airline serving the itinerary or legs thereof, or other data that may be stored in the reservation system 16 that corresponds to the travel itineraries. The host computer 12 assimilates the results of these queries and provides them in a web page or other electronic form to the user (as shown, for example, in FIGS. 4-7). The host computer 12 also translates the supplementary data retrieved from the reservation systems 16 (corresponding to individual travel itineraries presented to the user) into attributes information that may be presented in a first graphical image 34 (see FIGS. 4 and 5) that is displayed concurrently with the retrieved travel itineraries in the display listing 32. The attributes information may include, but is not limited to: a listing of communications amenities available on at least one leg of the retrieved itineraries (such as in-flight internet or telephone service); a listing of entertainment amenities available on at least one leg of the retrieved itineraries (such as in-flight satellite television or gaming); a listing of comfort amenities available on at least one leg of the retrieved itineraries (such as larger seat sizes, extra legroom, or expanded headroom); a listing of bonus amenities offered for purchasing the retrieved itineraries (such as rebate offers or bonus frequent flyer mile awards); and/or other convenience amenities (such as in-flight Electrical power outlets for use with passengers' electronic devices). Furthermore, in some embodiments, the attributes information may also include negative attributes corresponding to a particular travel product. Such negative attributes may include, but are not limited to: an air travel itinerary having historically late and/or delayed departure or arrival times; a hotel having a relatively low rating from travel services (such as AAA, or other rating services); a travel product provider having negative customer feedback as ascertained from a reservation system 16 and/or travel website; and other negative attributes.

According to some embodiments, the host computer 12 (or host computing element 12) further interrogates a translational database 17 (in communication with the host computer 12 and/or various reservation systems 16 via the network 14 (see FIG. 1A)) so as to be capable of translating the retrieved supplemental data corresponding to retrieved itineraries into attributes information corresponding to at least one leg of the retrieved itineraries. In some embodiments, the translational database 17 may comprise a computer system or electronic database comprising supplemental data that is retrieved by the host computer 12 in response to a user query and attributes information corresponding to particular items of supplemental data. For example, the translational database 17 may comprise a memory cache containing a translational template for translating supplemental data (such as data indicating that a Boeing 767 operated by United Airlines services a particular itinerary leg) into usable attributes information by accessing the translational template (which may indicate, for example, that all Boeing 767 aircraft operated by United Airlines provide in-flight satellite television service).

According to some embodiments, the translational database 17 may be capable of accessing reservation systems 16 or other computer systems (such as airline computer systems) in order to periodically update such translational templates. Thus, the translational database may be updated to indicate that certain supplemental data related to a retrieved itinerary equates to new or different attributes information. This updated translational database 17 embodiment may be especially desirable for translating supplemental data into bonus attributes information (such as rebate or bonus frequent flyer miles information), as such attributes may be periodically offered for limited times by one or more airlines for particular itineraries or legs thereof.

As illustrated in exploded FIG. 1B, the host computer system of the present invention is generally embodied as a typical computer, server or mainframe system depending on the embodiment. They system generally includes a processing element 20, such as a microprocessor, VLSI, ASIC, etc., a storage device 22, display 24, keyboard and mouse interface 26, and a network interface 28.

In some embodiments, the host computer system 12 polls the reservation system 16 for itinerary information and corresponding supplemental data each time a user enters a query (via a personal computer 18, for example). However, in some embodiments, such frequent availability and retrieval requests can slow down or disrupt the reservation system 16. Further, accessing the reservation system 16 may have an associated processing delay. For this reason, in some embodiments, the host computer 12 may further include a prepopulated cache 30 from which availability information and supplemental data corresponding to particular travel itineraries is derived for providing responses to user requests. Specifically, as shown in FIG. 1B, the host computer system 12 of the present invention includes an availability cache 30 located in the storage device 22. The availability cache 30 is populated with various itinerary information and corresponding supplemental data needed to properly respond to availability requests issued by users. In such embodiments, the supplemental data retrieved from the availability cache 30 may also be translated into attributes information, as described above, and presented to the user's personal computer 18 in a website listing.

It is noted here that the term customer and user may both used herein. These terms are for the most part used interchangeably. User may sometimes be used to refer to individuals or entities that maintain the system, as opposed to individuals or entities that purchase product. Further, the terms “departure dates” and “return dates” are used herein as specific to embodiments in which the product is an airline ticket. It is understood that other products with which the present invention is used may use the terms “start date of use” and “length of use.” For example, in some cases the travel itinerary retrieved by the host computer 12 may be a hotel room reservation, wherein the start date would be the day the customer arrives, and the customer would stay for a number of nights representing a length of stay, as opposed to use of a return date.

The various operations of the present invention may be performed either by hardware in the form of ASIC chips or other specialized hardware or by operation of software ran by a processing element. In the latter case, the storage device 22 may also further include the various computer software programs and modules used to implement the operations of the present invention.

As mentioned above and discussed in greater detail below, the systems, methods, and computer program products of the present invention provide product availability information (including the availability of low-cost travel itineraries and corresponding attributes information) to a user based on queries initiated by the user. Importantly, the systems, methods, and computer program products of the present invention may provide low-price fare options to a consumer for either selected dates of use or for a given range of dates of use. Furthermore, according to the embodiments of the present invention, the low-price fare options may be presented to the user via a graphical interface along with supplemental attributes information (including amenities, incentives, or other information) corresponding to the fare options (see generally FIGS. 4-7). For example, the systems, methods, and computer program products of the present invention are suited for providing a user with airfare information as well as supplemental attributes information corresponding to the listed airfares such as comfort amenities and/or incentives offered in conjunction with selected published airfares.

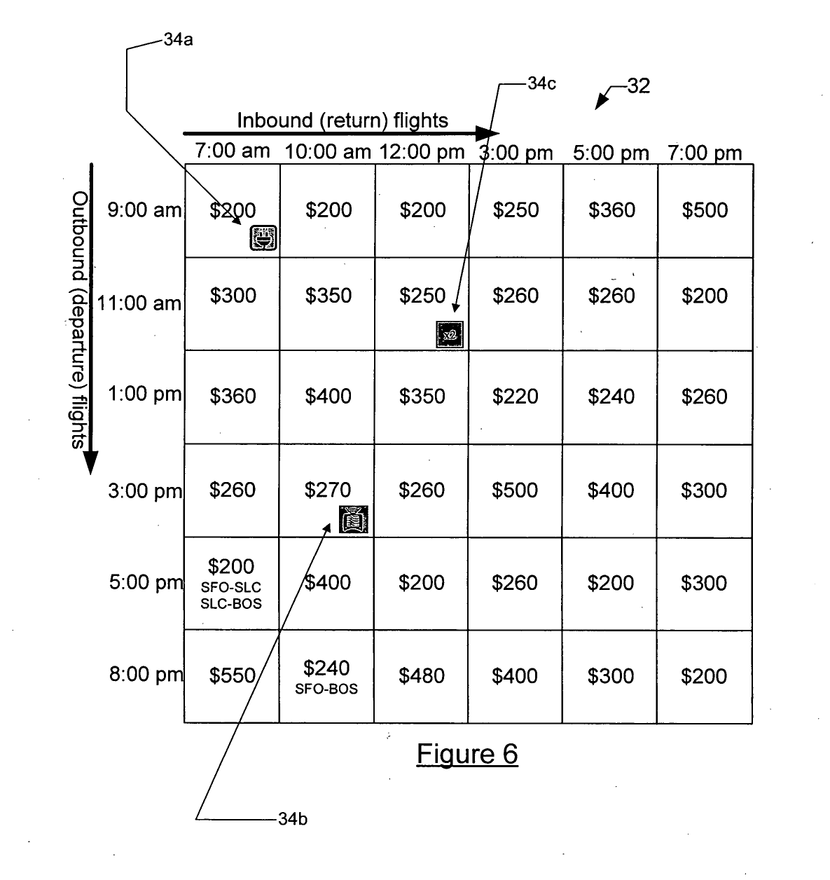

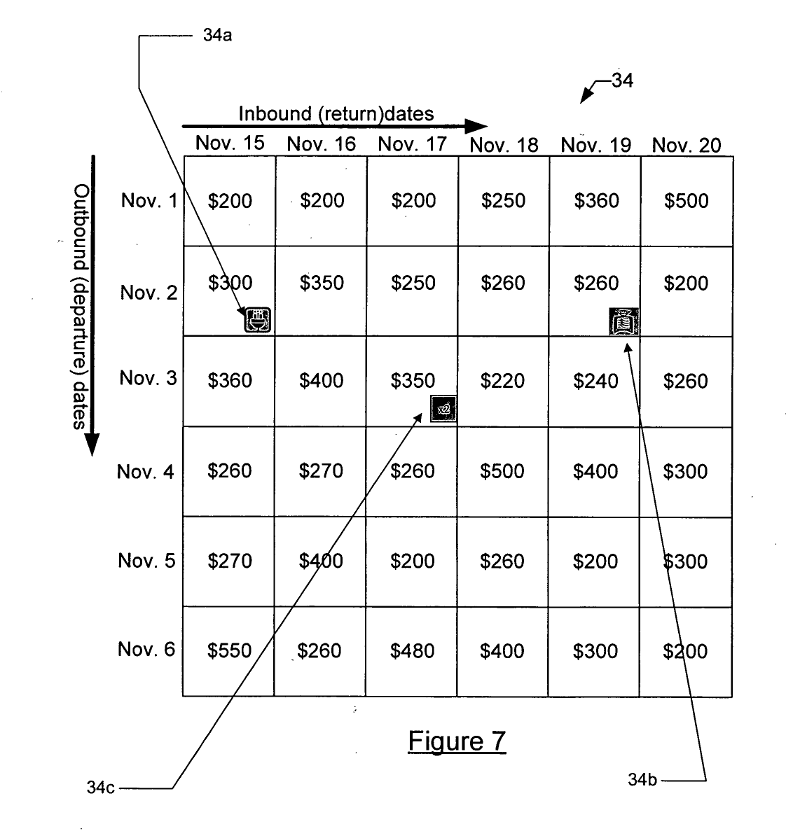

The systems, methods, and computer program products may provide a consumer with a website display 32 (displayed via a user's personal computer 18 or other user interface) including a sequential listing (see FIGS. 4 and 5) of travel itineraries and corresponding attributes information (depicted via a first graphical image 34, for example) in response to a user query that may, in some examples, comprise: a departure date, return date, departure location, destination, number of travelers, and seating or accommodation class. Furthermore, according to other embodiments, the embodiments of the present invention may generate a display 32 comprising a matrix or grid (see generally FIG. 6) of different low-priced itineraries retrieved by the host computer 12 from a reservation system 16 that are available for a selected departure and return date combination along with a corresponding listing of attributes information (in a first graphical image 34) to indicate amenities and incentives that may be offered with one or more of the itinerary options. Alternatively, the systems, methods, and computer program products of the present invention may provide a grid or matrix 32 that lists a plurality of different departure and return date combinations (see generally FIG. 7). For each departure-return combination, a retrieved low-price itinerary is provided along with supplemental attributes information (in the form of a first graphical image 34) that may be translated from supplemental data that is retrieved by the host computer 12 along with the listed itineraries.

Furthermore, according to some embodiments of the present invention, the user query may comprise one or more desired amenities, attributes, and/or supplemental attributes information such that the various embodiments of the present invention (described more fully below) may interrogate one or more reservation systems 16 and/or translational databases 17 such that the host computer 12 may retrieve one or more travel products meeting the user's request. For example, a user may, in some embodiments, search for flights based on the availability of an in-flight entertainment amenity, such that the user request comprises a search for the lowest-cost flights with in-seat power and in-seat satellite video entertainment.

FIG. 4 shows an exemplary itinerary results display 32 generated by embodiments of the present invention for a flight itinerary having a departure date, e.g., May 23 wherein the outbound flights are listed in order based on price of the itinerary (taking into account a selected return date that may have been input by a user via personal computer 18). As shown in FIG. 4, the host computing element (such as the host computer 12) provides results in the form of the display 32 to a user interface (such as a personal computer 18 in communication via network 14 with the host computing element 12, as shown in FIG. 1A), wherein the results comprise a listing of the retrieved itineraries and corresponding attributes information corresponding to the retrieved itineraries illustrated in a first graphical image 34 such that the user may be informed of the attributes information corresponding to the various retrieved itineraries that comply with the user query requirements. For example, and as described above, the supplemental attributes information may include information corresponding to amenities that may be offered on a particular aircraft type that is used to travel the leg of the determined itinerary that is displayed via the display 32. As shown in FIG. 4, such amenities may include electrical power outlets that are accessible from passenger seats throughout the aircraft. Furthermore, in some instances the first graphical image 34 may further comprise an interactive graphical image (such as a hyperlink 36) such that a user may enter a second input (secondary to a first user input comprising issuing a query to the host computer 12) comprising a selection of the interactive graphical image (such as a mouse-click on the hyperlink 36). In response to the second user input, the host computing element 12 may further provide a second graphical image 38, as shown in FIG. 5, wherein the second graphical image 38 may comprise a text or image “pop-up” or other display comprising additional supplemental information corresponding to the retrieved itineraries.

For example, as shown in FIGS. 4 and 5, in response to the initial user query comprising selecting a departure date and/or return date, the host computing element 12 may generate a listing of the retrieved itineraries, fares, and corresponding attributes information corresponding to the retrieved itineraries. As shown in FIG. 5, the supplemental information may be listed via a first graphical image 34 that lists a short summary of the supplemental information (or in some examples, an advertisement or promotional message corresponding to an amenity or special incentive offered by a particular airline). Furthermore, the first graphical image 34 may comprise an interactive graphical image 36 (such as a hyperlink, accessible by clicking a highlighted portion of the displayed text reading “more . . .” as shown in FIG. 5. Upon detecting a click of a computer mouse or other user input with respect to the interactive graphical image 36, the host computing element 12 may then be capable of generating a second graphical image 38 comprising a pop-up text box or other supplemental image that may provide details or further supplemental information corresponding to the availability, terms, or restrictions that may apply to the attribute or incentive offered via the supplemental information included in the display 32 of determined itineraries.

Furthermore, the first graphical images 34a, 34b, 34c may also be displayed as icons or pictograms denoting particular attributes availability corresponding to a retrieved itinerary, as shown in generally in FIGS. 6 and 7. Such icons 34a, 34b, 34c may also comprise interactive graphical images (such as hyperlinks or responsive icons) such that a user may choose to click on one of the first graphical images 34a, 34b, 34c (that may correspond to various attributes and/or amenities shown in conjunction with a retrieved itinerary). Thus, via the interactive graphical images, a user may gain access to additional or clarifying supplemental information that may be supplied by the host computing element 12 via a second graphical image 38 (comprising a pop-up text or graphics box, a secondary website, or other supplemental display that may be generated by the host computing element 12 and subsequently displayed via a display in communication with a personal computer 18 or other user interface).

According to some embodiments, the host computer 12 of the present system may be configured to provide a plurality of low airline fare prices and different flight itinerary options from various reservation systems 16 for a given departure and return date combination entered by a user, thereby allowing a user to view these different options and make a determination as to which fare and flight itinerary meets their goals. Such a system is described more fully in U.S. Provisional Patent Application Ser. No. 60/573,546, filed on May 21, 2004, entitled Systems, Methods, and Computer Program Products for Searching and Displaying Low Cost Product Availability Information for a Given Departure-Return Date Combination or Range of Departure-Return Date Combinations; the contents of which are incorporated herein.

For example, such embodiments may generate grid displays 32 as shown in FIGS. 6 and 7 respectively illustrate a results grid or matrix 32 listing the lowest cost itineraries (as opposed to a listing of all itineraries (having various costs) meeting the date requirements of a user query) for a selected departure, e.g., November 1, and return date, e.g., November 12. The rows of the grid 32 represent outbound flights for the November 1 departure date, while the columns represent inbound flights for the November 12 return date. Each cell of the grid represents an itinerary for a given outbound and inbound flight combination. Further, each cell is populated with a lowest available fare the given outbound and inbound combination. By studying this grid 32, a consumer can review all of the different flight itinerary combinations and the different prices and make an informed decision concerning choice of flight itineraries. In addition, for certain itineraries in the grid 32, attributes information may be displayed via pictogram or icons 34a, 34b, 34c that describe amenities, incentives, or other information corresponding to selected itineraries retrieved by the host computer 12 and displayed in the grid 32 via a user interface 18. For example, the grid 32 shown in FIG. 6 discloses that there is a flight leaving at 7:00 am that connects through Salt Lake City and returns at 5:00 pm for $200 and there is a direct flight that leaves at 10:00 am and returns at 8:00 pm for $240. Given both of these options, the consumer can determine which of these flight itineraries meet his/her needs either in terms of price or convenience. Furthermore, the grid 32 also discloses that there is a direct flight leaving at 10:00 am and returning at 3:00 pm for $270 that includes an entertainment amenity (such as in-flight satellite TV) as indicated by a first graphical image 34b that is displayed on the user's display 24 by the host computer 12. Furthermore, supplemental attributes information related to amenities and incentives may be shown, in correspondence with other itineraries shown in the grid 32, using other first graphical images 34a, 34c that correspond to in-flight Electrical power outlets (as indicated by the first graphical image 34a) or incentives such as double frequent flier miles for a particular itinerary (as indicated by first graphical image 34c).

FIG. 7 is somewhat different than FIG. 6 in that this grid 32 illustrates various low cost fares for a range of departure and return date combinations. The rows of the grid represent different return dates, e.g., November 15-20, while the columns represent different departure dates, e.g., November 1-6. Here again, a consumer can view the various available fares for the different departure and return date combinations and determine which of these solutions is acceptable in terms of price and/or convenience. As in the grid 32 of FIG. 6, various itineraries may be displayed along with corresponding supplemental information (as indicated by first graphical images 34a, 34b, 34c) related to various amenities or incentives such as: in-flight electrical power outlets (indicated by icon 34a), in-flight satellite television service (indicated by icon 34b), and double frequent flier mile itineraries (indicated by image 34c). Other images 34, text-based images, or interactive graphical images 36 (such as hyperlinks, as shown generally in FIGS. 4 and 5) may also be generated by the host computer 12 according to various embodiments of the present invention to indicate itineraries displayed within the grid 32 that may have been retrieved from the reservation system 16 along with supplemental information related to associated attributes, amenities, and/or incentives.

FIG. 2 is a generalized illustration of the operations performed by the systems, methods, and computer program products of the present invention to generate the listing, grid, and matrix displays 32 illustrated in FIGS. 4-7. The description of this operation is given by example to the display 32 listing of retrieved itineraries and attributes information shown in FIGS. 4-5 and to the system schematic shown generally in FIGS. 1A and 1B.

FIG. 2 shows a method for retrieving and displaying supplemental information (such as attributes and/or amenities information) corresponding to a plurality of travel itineraries selected from a database (such as a reservation system 16) in blocks 210-230, based on a query from a user, including a selected departure-return date combination, in a manner that reduces the burden on inventory systems 16. Block 210 comprises retrieving travel itineraries and data corresponding to the travel itineraries for the selected departure-return date combination from a reservation system 16. The retrieving step 210 may be performed by a host computer 12 (as described above) in response to a user query input via an interface (such as a user's personal computer 18 in communication with the host computer 12 and/or reservation system 16 via a network 14). The retrieving step 210 comprises retrieving both a listing of itineraries (meeting the requirements of the user query) as well as supplemental data corresponding to the retrieved itineraries. As described generally above, the supplemental data may be any data stored in the reservation system 16 (or in a prepopulated data cache 30 within the host computer 12) that corresponds to itineraries that meet the requirements of the user query. Such supplemental data may include, as described above, an aircraft type, airline, or other service provider serving at least one leg of the retrieved itinerary.

Block 220 illustrates another step in the method of the present invention comprising translating the data corresponding to retrieved travel itineraries into attributes information corresponding to at least one leg of the retrieved travel itineraries. This step may also be performed by the host computer 12 (or a processing element 20 thereof) of the system of the present invention, wherein the host computer 12 is configured to be capable of translating retrieved data (corresponding to the retrieved itineraries) into attributes information corresponding to the retrieved itineraries. The translating step 220 may be performed using a translational template stored in the storage device 22 of the host computer. The translational template may include a translation key or other information template that is accessible by the processing portion 20 of the host computer 12 such that the host computer 12 may be capable of reading retrieved data and translating it into attributes information corresponding to the various retrieved itineraries. For example, the transactional template may contain attributes information (such as information on communications, comfort, entertainment, or other amenities that may be available in travel itineraries served by particular aircraft types). In other examples, the transactional template may contain information on bonus amenities (such as rebates, extra frequent flyer miles, or other incentives) that may be offered on particular airlines for particular itineraries or legs thereof. The attributes may also comprise negative attribute information, such as the lack of overhead storage space and/or headroom in a particular aircraft type. Thus, the processing element 20 may access the translational template in order to translate the retrieved data (such as aircraft type or airline) into attributes information that may be provided in a display 32 to the user along with the listings of retrieved itineraries (as described below).

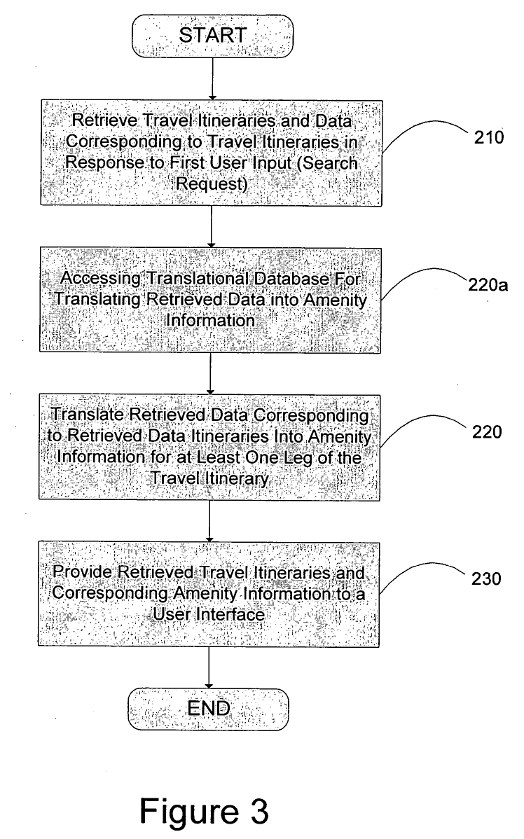

FIG. 3 shows an additional method step in block 220a that may be performed according to some method embodiments of the present invention. Step 220a may comprise interrogating a translational database 17 comprising data and corresponding attributes information (listed in a translational template, for example, as described above), so as to translate the data corresponding to retrieved itineraries into attributes information corresponding to at least one leg of the retrieved itineraries. Thus, according to some embodiments, the host computer 12 of the system embodiments of the present invention, may access (via a network 14) the translational database to retrieve a translational key or template that may aid in translating the supplemental data retrieved from the reservation system 16 to attributes information that may be of interest to a user when displayed in conjunction with a listing of the retrieved itineraries (as described below with respect to step 230). The translational database 17 may further be in communication with a reservation system 16 or other database or computer systems so as to be capable of being updated with translational keys or templates that reveal currently available attributes, amenities, or incentives that may be revealed by supplemental data retrieved along with low-cost itineraries from the reservation systems 16.

Block 230 illustrates a step of the method of the present invention comprising providing the retrieved travel itineraries and translated attributes information (generated in the translating step 220 (and 220a (as described below)) corresponding to the retrieved travel itineraries to an interface 18 (such as a user's personal computer 18), such that the user may be informed of the attributes information corresponding to at least one leg of the retrieved travel itineraries. This step may also be performed by the host computer 12 of the system of the present invention (or the processing portion 20 thereof). For example, the host computer 12 may arrange the retrieved travel itineraries into a listing and generate a first graphical image 34 to illustrate attributes information corresponding to one or more of the retrieved itineraries. Thus, the host computer 12 may be capable of generating a display 32 (as shown in FIGS. 4-7) of retrieved itineraries and corresponding attributes information (where available) and sending the display 32 information to a user interface 18 that may be in communication with the host computer 12 via a network 14 (such as the internet, or other network).

As described above with respect to FIGS. 4-7 (and particularly in FIGS. 4 and 5), the providing step illustrated in block 230 may further comprise providing the retrieved travel itineraries and translated attributes information to said interface in a first graphical image 34. For example, as shown in FIGS. 4 and 5, the first graphical image 34 may comprise a text message listed concurrently or adjacent to a listing of a particular retrieved itinerary as part of a list of retrieved itineraries provided to a user interface 18 by the host computer 12 in response to a user query. In other embodiments, as shown in FIGS. 6-7, the first graphical image 34a, 34b, 34c may comprise an icon or pictogram identifying a particular attribute or incentive that may be offered in conjunction with a particular retrieved itinerary. Such attributes information may include, but is not limited to a communications amenity available on at least one leg of the retrieved itineraries; an entertainment amenity available on at least one leg of the retrieved itineraries; a comfort amenity available on at least one leg of the retrieved itineraries; a bonus amenity (such as a rebate or incentive) offered for purchasing the retrieved itineraries; and/or other amenities information (including negative attributes that may be associated with one or more of the retrieved itineraries). Furthermore, in some embodiments, the providing step of step 230 further comprises providing a first graphical image 34 that also comprises an interactive graphical image 36 such as a hyperlink (see, for example, element 36 in FIGS. 4 and 5) or other interactive graphical image.

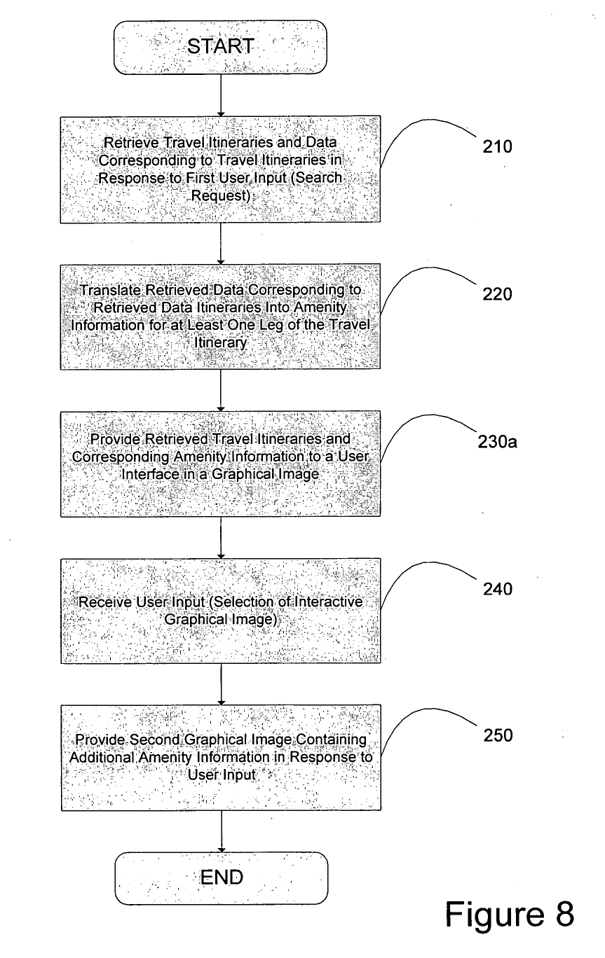

Thus, in some method embodiments shown in FIG. 8, the providing step 230a may comprise providing retrieved travel itineraries and corresponding attributes information to a user (via a user interface 18) in an interactive graphical image 36 (such as a hyperlink or interactive icon as shown in FIGS. 4-5). Furthermore, the method embodiment illustrated generally in FIG. 8 further comprises step 240 comprising receiving a user input from the user (such as a mouse click, keystroke, or other user input) wherein the user input comprises a selection of the interactive graphical image 36. In addition, as shown in step 250, the method further comprises providing a second graphical image 38 (such as a pop-up text box, web page, graphic or other graphical image (such as the pop-up box 38 illustrated in FIG. 5) comprising additional translated attributes information corresponding to the retrieved itineraries, in response to the user input received in step 240. As shown generally in FIG. 5, the additional attributes information displayed via the second graphical image 38 may include specific information related to accessing the attribute, restrictions associated with the attribute, advertisements or promotional information associated with the attribute, and other information that may be utilized by the user to make an informed purchasing decision in choosing to purchase a retrieved itinerary (or other product option) having such an attribute offered therewith.

As mentioned above, although the specific embodiments are directed to use of the present invention with airline flights, the present invention is not so limited. The present invention can be used with rail and bus itineraries, hotels, cruises, restaurants, car rentals, events including sports and leisure activities, etc. For example, if the system is used for hotels, the system could display amenities and/or offers relating to the hotel, such as whether the hotel has a spa, restaurant, proximity to an event or landmark, etc. It may also provide specific attributes and/or offers associated with specific rooms in the hotel. For car rentals, the system may provide offers provided by the car rental company. Further, the system may provide attributes and/or offer associated with individual cars, such as whether the car has special safety features, includes satellite radio or GPS system, etc. Similar type information would be provided in the train, cruise, and events embodiments.

Furthermore, as described generally above, some embodiments of the present invention are used to search for and display flight attributes centering on airline, aircraft type, and origination/destination to determine which flights have particular amenities. However, according to some other embodiments of the present invention, the system may be used to search for and display other attributes that may be linked to flight attributes and/or negative travel product attributes that may include, but are not limited to: flight departure/arrival time (for example, Airline 1 may serve a complimentary continental breakfast on its morning shuttle flights between LaGuardia and Reagan National), flight number range (for example, Airline 1's flights numbered between 2000 and 2399 may use a aircraft variant with in-seat satellite video), fare class (Airline 2's flights sold in N class may only offer 50 percent frequent flier mile accrual), originating and/or destination airport and/or city (for example, Airline 3 may service itineraries departing from Raleigh-Durham with regional jets having reduced headroom and/or overhead storage), length of stay (calculated, for example, by number of nights requested at a hotel and/or number of days between outbound and return flights), number of passengers traveling (for example, some travel product providers may offer group discounts or amenities), fare basis code, booking code, advance purchase days (for example, identification of the advance purchase in relation to the current day and/or the time left before the advanced purchase expires for the fare shown), duration of travel itinerary (which may include both “time in the air” for airline itineraries, and total time (including layover time)), and price range of the product.

In addition to providing apparatus and methods, the present invention also provides computer program products for performing the operations described above. The computer program products have a computer readable storage medium having computer readable program code means embodied in the medium. With reference to FIG. 1B, the computer readable storage medium may be part of the storage device 22, not shown, and may implement the computer readable program code means to perform the above discussed operations.

In this regard, FIGS. 2 and 3 are block diagram illustrations of methods, systems and program products according to the invention. It will be understood that each block or step of the block diagram and combinations of blocks in the block diagram can be implemented by computer program instructions. These computer program instructions may be loaded onto a computer or other programmable apparatus to produce a machine, such that the instructions which execute on the computer or other programmable apparatus create means for implementing the functions specified in the block diagram, flowchart or control flow block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the block diagram, flowchart or control flow block(s) or step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the block diagram, flowchart or control flow block(s) or step(s).

Accordingly, blocks or steps of the block diagram, flowchart or control flow illustrations support combinations of means for performing the specified functions, combinations of steps for performing the specified functions and program instruction means for performing the specified functions. It will also be understood that each block or step of the block diagram, flowchart or control flow illustrations, and combinations of blocks or steps in the block diagram, flowchart or control flow illustrations, can be implemented by special purpose hardware-based computer systems which perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A system for retrieving and displaying supplemental information corresponding to one or more travel products selected from a database based on a search request in a manner that reduces the burden on inventory systems, the system comprising:
an inventory system comprising travel products wherein for at least some of the travel products said inventory system further comprises data representing at least one of attributes and offers associated with the travel products; and
a host computing element in communication with said inventory system for running queries on said inventory system based on a user request;
wherein said host computing element retrieves travel products from said inventory system based on the user request and displays retrieved travel products meeting the user request to the user, and
wherein for those retrieved travel products having associated data representing the attributes and/or offers, said host computing element displays the data representing the attributes and/or offers with the retrieved travel products.

2. A system according to claim 1, wherein said host computing element further translates the data associated with the retrieved travel products into attributes and/or offer information corresponding to the retrieved travel products.

3. A system according to claim 1, wherein said host computing element further interrogates a translational database comprising data and corresponding attributes and/or offers information, so as to translate the data associated with the retrieved travel products into attributes and/or offer information corresponding to the retrieved travel products.

4. A system according to claim 3, wherein when said host computing element retrieves a travel products, said host computing element further determines whether attributes and/or offers information stored in said translational database correspond to the retrieved travel products.

5. A system according to claim 1, wherein said host computing system further displays the retrieved travel products to the user in a graphical display comprising at least one interactive graphical image.

6. A system according to claim 5, wherein said host computing element further receives a user input from the user, the user input comprising a selection of the interactive graphical image, and wherein said host computing element further provides a second graphical image comprising additional attributes and/or offer information corresponding to the retrieved travel products.

7. A system according to claim 3, wherein the travel product is an airline flight on a selected type of aircraft, wherein said translational database comprises data indicating attributes offered with the selected type of aircraft, and wherein said host computing element translates the data into the attributes and/or offer information and displays the attributes associated with the selected type of aircraft when displaying the airline flight

8. A system according to claim 3, wherein the travel product is an airline flight on a selected airline, wherein said translational database comprises data indicating attributes and/or offers offered by the selected airline, and wherein said host computing element translates the data into the attributes and/or offers information and displays the attributes and/or offers offered by the selected airline when displaying the airline flight.

9. A system according to claim 3, wherein the travel product is a hotel, wherein said translational database comprises data indicating attributes and/or offers associated with either the hotel or selected rooms of the hotel, and wherein said host computing element translates the data into the attributes and/or offers information and displays the attributes and/or offers associated with the hotel or hotel rooms when displaying the hotel.

10. A system according to claim 3, wherein the travel product is a automobile rental, wherein said translational database comprises data indicating attributes and/or offers associated with the automobile rental, and wherein said host computing element translates the data into the attributes and/or offers information and displays the attributes and/or offers associated with the automobile rental when displaying the automobile rental.

11. A system according to claim 3, wherein the travel product is an event, wherein said translational database comprises data indicating attributes and/or offers associated with the event, and wherein said host computing element translates the data into the attributes and/or offers information and displays the attributes and/or offers associated with the event when displaying the event.

12. A system according to claim 1, wherein the travel products are individual flight segments between a departure airport and an arrival airport, wherein at least one of the attributes and/or offers is associated with individual flight segments, and wherein said host computing element displays the retrieved individual flight segments and provides an indication to the user of which of the retrieved individual flight segments have associated attributes and/or offers.

13. A system according to claim 12, wherein two or more the individual flight segments constitute a flight itinerary between a departure location and a destination, and wherein said host computing element displays the flight itinerary and displays to the user an indication of attributes and/or offers associated with the individual flight segments constituting the flight itinerary.

14. A system according to claim 1, wherein the travel product is an airline flight and wherein said host computing system retrieves data comprising at least one of:
an aircraft type used in the airline flight;
a service provider providing service for the airline flight; and
at least one geographical location representing a departure location or a destination for the airline flight.

15. A system according to claim 2, wherein the travel product is an airline flight and wherein said host computing element translates the retrieved data into attributes and/or offers information corresponding to at least one of:
a communications amenity available on at least one leg of the airline flight;
an entertainment amenity available on at least one leg of the airline flight;
a comfort amenity available on at least one leg of the airline flight;
a bonus offer offered for purchasing the airline flight; and
a negative attribute corresponding to at least one leg of the airline flight.

16. A method according to claim 1, wherein the user request further comprises at least one of the data representing at least one of attributes and offers associated with the travel products.

17. A method for retrieving and displaying supplemental information corresponding to one or more travel products selected from a database based on a search request in a manner that reduces the burden on an inventory system, the inventory system comprising travel products wherein for at least some of the travel products said inventory system further comprises data representing at least one of attributes and offers associate with the travel products, the method comprising:
retrieving travel products from an inventory system based on a user request;
displaying retrieved travel products meeting the user request to the user;
displaying data representing the attributes and/or offers for those retrieved travel products having associated data representing the attributes and/or offers with the retrieved travel products.

18. A method according to claim 17, further comprising translating the data associated with the retrieved travel products into attributes and/or offers information corresponding to the retrieved travel products.

19. A method according to claim 17, further comprising interrogating a translational database comprising data and corresponding attributes and/or offers information so as to translate the data associated with the retrieved travel products into attributes and/or offers information corresponding to the retrieved travel products.

20. A method according to claim 18, wherein the translating step further comprises determining whether attributes and/or offers information stored in said translational database correspond to the retrieved travel products.

21. A method according to claim 16, wherein the displaying step further comprises displaying the retrieved travel products to the user in a graphical display comprising at least one interactive graphical image.

22. A method according to claim 21, further comprising receiving a user input from the user, the user input comprising a selection of the interactive graphical image, and wherein the displaying step further comprises displaying a second graphical image comprising additional attributes and/or offer information corresponding to the retrieved travel products.

23. A method according to claim 19, wherein the travel product is an airline flight on a selected type of aircraft, wherein said translational database comprises data indicating attributes offered with the selected type of aircraft, wherein the translating step further comprises translating the data into the attributes and/or offer information and wherein the displaying step further comprises displaying the attributes associated with the selected type of aircraft when displaying the airline flight

24. A method according to claim 19, wherein the travel product is an airline flight on a selected airline, wherein said translational database comprises data indicating attributes and/or offers offered by the selected airline, and wherein the translating step further comprises translating the data into the attributes and/or offers information and wherein the displaying step further comprises displaying the attributes and/or offers offered by the selected airline when displaying the airline flight.

25. A method according to claim 19, wherein the travel product is a hotel, wherein said translational database comprises data indicating attributes and/or offers associated with either the hotel or selected rooms of the hotel, and wherein the translating step further comprises translating the data into the attributes and/or offers information and wherein the displaying step further comprises displaying the attributes and/or offers associated with the hotel or hotel rooms when displaying the hotel.

26. A method according to claim 19, wherein the travel product is a automobile rental, wherein said translational database comprises data indicating attributes and/or offers associated with the automobile rental, and wherein the translating step further comprises translating the data into the attributes and/or offers information and wherein the displaying step further comprises displaying the attributes and/or offers associated with the automobile rental when displaying the automobile rental.

27. A method according to claim 19, wherein the travel product is an event, wherein said translational database comprises data indicating attributes and/or offers associated with the event, and wherein the translating step further comprises translating the data into the attributes and/or offers information and wherein the displaying step further comprises displaying the attributes and/or offers associated with the event when displaying the event.

28. A method according to claim 19, wherein the travel products are individual flight segments between a departure airport and an arrival airport, wherein at least one of the attributes and/or offers is associated with individual flight segments, and wherein the displaying step further comprises displaying the retrieved individual flight segments with an indication of which of the retrieved individual flight segments have associated attributes and/or offers.

29. A method according to claim 28, wherein two or more the individual flight segments constitute a flight itinerary between a departure location and a destination, and wherein the displaying step further comprises displaying the flight itinerary with an indication of attributes and/or offers associated with the individual flight segments constituting the flight itinerary.

30. A method according to claim 17, wherein the travel product is an airline flight and wherein the retrieving step further comprises retrieving data comprising at least one of:
an aircraft type used in the airline flight;
a service provider providing service for the airline flight; and
at least one geographical location representing a departure location or a destination for the airline flight.

31. A method according to claim 17, wherein the travel product is an airline flight and wherein the translating step further comprises translating the retrieved data into attributes and/or offers information corresponding to at least one of:
a communications amenity available on at least one leg of the airline flight;
an entertainment amenity available on at least one leg of the airline flight;
a comfort amenity available on at least one leg of the airline flight; and
a bonus offer offered for purchasing the airline flight; and
a negative attribute corresponding to at least one leg of the airline flight.

32. A method according to claim 17, wherein the user request further comprises at least one of the data representing at least one of attributes and offers associated with the travel products.

33. A computer program product for retrieving and displaying supplemental information corresponding to one or more travel products selected from a database based on a search request in a manner that reduces the burden an inventory system, the inventory system comprising travel products wherein for at least some of the travel products said inventory system further comprises data representing at least one of attributes and offers associate with the travel products, the computer program product comprising a computer-readable storage medium having computer-readable program code instructions stored therein comprising:
first computer instruction means for retrieving travel products from an inventory system based on a user request;
second computer instruction means for displaying retrieved travel products meeting the user request to the user; and
third computer instruction means for displaying data representing the attributes and/or offers for those retrieved travel products having associated data representing the attributes and/or offers with the retrieved travel products.

34. A computer program product according to claim 33, further comprising fourth computer instruction means for translating the data associated with the retrieved travel products into attributes and/or offers information corresponding to the retrieved travel products.

35. A computer program product according to claim 33, further comprising fifth computer instruction means for interrogating a translational database comprising data and corresponding attributes and/or offers information so as to translate the data associated with the retrieved travel products into attributes and/or offers information corresponding to the retrieved travel products.

36. A computer program product according to claim 34, wherein the fourth computer instruction means for translating step further comprises sixth computer instruction means for determining whether attributes and/or offers information stored in said translational database correspond to the retrieved travel products.

37. A computer program product according to claim 33, wherein the third computer instruction means for displaying step further comprises seventh computer instruction means for displaying the retrieved travel products to the user in a graphical display comprising at least one interactive graphical image.

38. A computer program product according to claim 37, further comprising eighth computer instruction means for receiving a user input from the user, the user input comprising a selection of the interactive graphical image, and wherein the third computer instruction means for displaying step further comprises ninth computer instruction means for displaying a second graphical image comprising additional attributes and/or offer information corresponding to the retrieved travel products.

39. A computer program product according to claim 35, wherein the travel product is an airline flight on a selected type of aircraft, wherein said translational database comprises data indicating attributes offered with the selected type of aircraft, wherein the fourth computer instruction means for translating further comprises ninth computer instruction means for translating the data into the attributes and/or offer information and wherein the third computer instruction means for displaying further comprises tenth computer instruction means for displaying the attributes and/or offer information associated with the selected type of aircraft when displaying the airline flight.

40. A computer program product according to claim 35, wherein the travel product is an airline flight on a selected airline, wherein said translational database comprises data indicating attributes and/or offers offered by the selected airline, and wherein the fourth computer instruction means for translating further comprises eleventh computer instruction means for translating the data into the attributes and/or offers information and wherein the third computer instruction means for displaying further comprises twelfth computer instruction means for displaying the attributes and/or offers offered by the selected airline when displaying the airline flight.

41. A computer program product according to claim 35, wherein the travel product is a hotel, wherein said translational database comprises data indicating attributes and/or offers associated with either the hotel or selected rooms of the hotel, and wherein the fourth computer instruction means for translating further comprises thirteenth computer instruction means for translating the data into the attributes and/or offers information and wherein the third computer instruction means for displaying further comprises fourteenth computer instruction means for displaying the attributes and/or offers associated with the hotel or hotel rooms when displaying the hotel.

42. A computer program product according to claim 35, wherein the travel product is a automobile rental, wherein said translational database comprises data indicating attributes and/or offers associated with the automobile rental, and wherein the fourth computer instruction means for translating further comprises fifteenth computer instruction means for translating the data into the attributes and/or offers information and wherein the third computer instruction means for displaying further comprises sixteenth computer instruction means for displaying the attributes and/or offers associated with the automobile rental when displaying the automobile rental.

43. A computer program product according to claim 35, wherein the travel product is an event, wherein said translational database comprises data indicating attributes and/or offers associated with the event, and wherein the fourth computer instruction means for translating further comprises seventeenth computer instruction means for translating the data into the attributes and/or offers information and wherein the third computer instruction means for displaying further comprises eighteenth computer instruction means for displaying the attributes and/or offers associated with the event when displaying the event.

44. A computer program product according to claim 33, wherein the travel products are individual flight segments between a departure airport and an arrival airport, wherein at least one of the attributes and/or offers is associated with individual flight segments, and wherein the third computer instruction means for displaying further comprises nineteenth computer instruction means for displaying the retrieved individual flight segments with an indication of which of the retrieved individual flight segments have associated attributes and/or offers.

45. A computer program product according to claim 44, wherein two or more the individual flight segments constitute a flight itinerary between a departure location and a destination, and wherein the third computer instruction means for displaying further comprises twentieth computer instruction means for displaying the flight itinerary with an indication of attributes and/or offers associated with the individual flight segments constituting the flight itinerary.

46. A computer program product according to claim 33, wherein the travel product is an airline flight and wherein the first computer instruction means for retrieving further comprises twenty-first computer instruction means for retrieving data comprising at least one of:
an aircraft type used in the airline flight;
a service provider providing service for the airline flight; and
at least one geographical location representing a departure location or a destination for the airline flight.

47. A computer program product according to claim 34, wherein the travel product is an airline flight and wherein the fourth computer instruction means for translating further comprises twenty-second computer instruction means for translating the retrieved data into attributes and/or offers information corresponding to at least one of:
a communications amenity available on at least one leg of the airline flight;
an entertainment amenity available on at least one leg of the airline flight;
a comfort amenity available on at least one leg of the airline flight; and
a bonus offer offered for purchasing the airline flight; and
a negative attribute corresponding to at least one leg of the airline flight.

48. A computer program product according to claim 33, wherein the user request further comprises at least one of the data representing at least one of attributes and offers associated with the travel products.
